(19) United States
(12) Patent Application Publication
(10) Pub. No.: US 2019/0380280 A1
(43) Pub. Date: Dec. 19, 2019

(54) HANDHELD PLANT COMPRESSION TOOL

(71) Applicant: Khalil Wallace-Jones, Albuquerque, NM (US)

(72) Inventor: Khalil Wallace-Jones, Albuquerque, NM (US)

(21) Appl. No.: 16/410,830

(22) Filed: May 13, 2019

Related U.S. Application Data
(60) Provisional application No. 62/685,204, filed on Jun. 14, 2018.

(51) Int. Cl. A01G 7/06; B25B 7/02

(52) U.S. Cl. CPC A01G 7/06; A01G 22/15; B25B 7/02

(57) ABSTRACT

A handheld plant compression tool for performing high-stress training. The tool includes an upper shaft having a plurality of upper shaft notches disposed along an edge of the upper shaft. The plurality of upper shaft notches have rounded shapes that vary in size. The tool includes a lower shaft having a plurality of lower shaft notches disposed along an edge of the lower shaft. The plurality of lower shaft notches have rounded shapes that vary in size. The tool includes a handle attached to or integrated with one or both of the upper shaft and the lower shaft. The upper shaft and the lower shaft are coupled to each other at a pivot point. A plurality of apertures are formed by the plurality of upper shaft notches and the plurality of lower shaft notches when the tool is in use.

### CROSS-REFERENCES TO RELATED APPLICATIONS

This application is a non-provisional of and claims the benefit of priority to U.S. Provisional Patent Application No. 62/685,204, filed Jun. 14, 2018, entitled “GARDEN TOOL DEVICE,” the content of which is herein incorporated in its entirety.

### BACKGROUND OF THE INVENTION

Various techniques can be used during plant growth to increase the quality and yield of the plant. Among these include low-stress training and high-stress training, which aim to alter the chemical balance in the plants. During low-stress training, the plant is bent as it grows and branches that become too long are tied down. When the top of the plant is pulled downward, certain chemicals can be distributed more evenly in the plant. Furthermore, if the plant is tied down around a pot, the stalks of the plant can grow around the pot, exposing a larger number of bud sights at a level height. Upon entering the flowering stage, certain plants, such as a cannabis plant, can produce colas that will sprout upwards and produce an even level of healthy colas.

High-stress training is a technique where the plant is stressed by hurting it slightly in a planned way. During high-stress training, alternatively referred to as super cropping, instead of tying down the top of the plant, a branch is bent until the fibers break and the plant folds over. This is done without snapping the branch or tearing the skin of the stalk. This can be accomplished by identifying a location at which to break the branch and compressing the branch at that location. In some cases, the affected branch is bent until it achieves an angle equal to or less than 90 degrees. The affected branch can also be secured in a manner that is will not harm the rest of the plant. This can allow other portions of the plant to have more exposure to light, allowing them to catch up to the broken branch.

Current methods of implementing high-stress training require significant time, effort, and expertise for a user to perform. An unskilled user may damage the plant leading to infection when attempting to perform high-stress training. Presently, there is no solution for a user to effectively high-stress train a plant without many years of training and practice.

### SUMMARY OF THE INVENTION

Examples given below provide a summary of the present invention. As used below, any reference to a series of examples is to be understood as a reference to each of those examples disjunctively (e.g., “Examples 1-4” is to be understood as “Examples 1, 2, 3, or 4”).

Example 1 is a handheld plant compression tool comprising: an upper shaft having a plurality of upper shaft notches disposed along an edge of the upper shaft, the plurality of upper shaft notches varying in size and having rounded shapes; a lower shaft having a plurality of lower shaft notches disposed along an edge of the lower shaft, the plurality of lower shaft notches varying in size and having rounded shapes; and a handle attached to or integrated with one or both of the upper shaft and the lower shaft; wherein the upper shaft and the lower shaft are coupled to each other at a pivot point such that, when the upper shaft or the lower shaft is rotated about the pivot point by moving the handle, the edge of the upper shaft interfaces with the edge of the lower shaft, and a plurality of apertures are formed by the plurality of upper shaft notches and the plurality of lower shaft notches.

Example 2 is the handheld plant compression tool of example(s) 1, wherein the plurality of upper shaft notches have semicircular shapes.

Example 3 is the handheld plant compression tool of example(s) 1-2, wherein the plurality of lower shaft notches have semicircular shapes.

Example 4 is the handheld plant compression tool of example(s) 1-3, wherein, when the edge of the upper shaft interfaces with the edge of the lower shaft, the plurality of apertures have circular shapes.

Example 5 is the handheld plant compression tool of example(s) 1-4, wherein, when the edge of the upper shaft interfaces with the edge of the lower shaft, the plurality of apertures have elongated rounded shapes.

Example 6 is the handheld plant compression tool of example(s) 1-5, wherein the plurality of apertures are elongated with respect to a longitudinal direction of the upper shaft and the lower shaft.

Example 7 is the handheld plant compression tool of example(s) 1-6, wherein the plurality of apertures are elongated with respect to a radial direction of the upper shaft and the lower shaft.

Example 8 is the handheld plant compression tool of example(s) 1-7, wherein the plurality of upper shaft notches include: a first upper notch defined by a first upper notch height; a second upper notch defined by a second upper notch height, wherein the second upper notch height is greater than the first upper notch height; and a third upper notch defined by a third upper notch height, wherein the third upper notch height is greater than the second upper notch height.

Example 9 is the handheld plant compression tool of example(s) 1-8, wherein a width of the edge of the upper shaft is greater than each of the first upper notch height, the second upper notch height, and the third upper notch height.

Example 10 is the handheld plant compression tool of example(s) 1-9, wherein the plurality of lower shaft notches include: a first lower notch defined by a first lower notch height; a second lower notch defined by a second lower notch height, wherein the second lower notch height is greater than the first lower notch height; and a third lower notch defined by a third lower notch height, wherein the third lower notch height is greater than the second lower notch height.

Example 11 is the handheld plant compression tool of example(s) 1-10, wherein a width of the edge of the lower shaft is greater than each of the first lower notch height, the second lower notch height, and the third lower notch height.

Example 12 is a hand tool comprising: an upper shaft having a plurality of upper shaft notches disposed along an edge of the upper shaft, the plurality of upper shaft notches varying in size and having rounded shapes; and a lower shaft having a plurality of lower shaft notches disposed along an edge of the lower shaft, the plurality of lower shaft notches varying in size and having rounded shapes; wherein the upper shaft and the lower shaft are coupled to each other at a pivot point such that, when the upper shaft or the lower shaft is rotated about the pivot point, the edge of the upper shaft interfaces with the edge of the lower shaft, and a plurality of apertures are formed by the plurality of upper shaft notches and the plurality of lower shaft notches.

Example 13 is the hand tool of example(s) 12, wherein the plurality of upper shaft notches have semicircular shapes.

Example 14 is the hand tool of example(s) 12, wherein the plurality of lower shaft notches have semicircular shapes.

Example 15 is the hand tool of example(s) 12, wherein, when the edge of the upper shaft interfaces with the edge of the lower shaft, the plurality of apertures have circular shapes.

Example 16 is the hand tool of example(s) 12, wherein, when the edge of the upper shaft interfaces with the edge of the lower shaft, the plurality of apertures have elongated rounded shapes.

Example 17 is the hand tool of example(s) 16, wherein the plurality of apertures are elongated with respect to a longitudinal direction of the upper shaft and the lower shaft.

Example 18 is the hand tool of example(s) 16, wherein the plurality of apertures are elongated with respect to a radial direction of the upper shaft and the lower shaft.

Example 19 is the hand tool of example(s) 12, wherein the plurality of upper shaft notches include: a first upper notch defined by a first upper notch height; a second upper notch defined by a second upper notch height, wherein the second upper notch height is greater than the first upper notch height; and a third upper notch defined by a third upper notch height, wherein the third upper notch height is greater than the second upper notch height.

Example 20 is the hand tool of example(s) 19, wherein a width of the edge of the upper shaft is greater than each of the first upper notch height, the second upper notch height, and the third upper notch height.

Example 21 is the hand tool of example(s) 12, wherein the plurality of lower shaft notches include: a first lower notch defined by a first lower notch height; a second lower notch defined by a second lower notch height, wherein the second lower notch height is greater than the first lower notch height; and a third lower notch defined by a third lower notch height, wherein the third lower notch height is greater than the second lower notch height.

Example 22 is the hand tool of example(s) 21, wherein a width of the edge of the lower shaft is greater than each of the first lower notch height, the second lower notch height, and the third lower notch height.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 illustrates a perspective view of a plant compression tool, according to some embodiments of the present invention.

FIG. 2 illustrates a side view of a plant compression tool, according to some embodiments of the present invention.

FIG. 3 illustrates a side view of an upper shaft and a lower shaft of a plant compression tool, according to some embodiments of the present invention.

FIG. 4 illustrates a side view of an upper shaft and a lower shaft of a plant compression tool, according to some embodiments of the present invention.

FIG. 5 illustrates a side view of an upper shaft and a lower shaft of a plant compression tool, according to some embodiments of the present invention.

FIG. 6 illustrates a side view of an example of using a plant compression tool to compress a plant stem in the longitudinal direction.

FIG. 7 illustrates a side view of an example of using a plant compression tool to compress a plant stem in the radial direction.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label irrespective of the suffix.

### DETAILED DESCRIPTION OF THE INVENTION

In some embodiments described herein, a garden compression tool is provided that may be used to accomplish high-stress training. The tool can include a pair of metal first class levers joined at a fulcrum. The fulcrum can be positioned at a point ⅔ of the lengths of the levers creating “jaws” on the shorter end of the fulcrum and an ergonomic handle design on the longer end of the fulcrum. The tool can include moveable rubber coated jaws that contain different sized grooves for different sized plant stems. The grooves can form different sized diameter hollowed out chambers that coincide with the plant age and size.

High-stress training is a technique that has been used by gardeners for centuries in which a plant is stressed by slightly hurting it in a planned way. The technique requires bending and breaking stems (without breaking the plant until it “bleeds”). This sends a damage signal to the plant that causes chemical changes in the plant that positively influence growth from a grower's perspective. The major chemical change that takes place in a plant from high-stress training involves the alteration of a natural growth hormone in the plant called auxin. Auxin is a powerful growth hormone produced naturally by plants. Auxins promote stem elongation, inhibiting growth of lateral buds. They are produced in the stem, buds, and root tips. Auxins also promote fruit development. Through-high stress training, growers coax plants to develop more than just one towering cola. Lower areas on the plant will burst into blossom. As a result, the plant will grow bushier.

One disadvantage of high-stress training is that if it is done improperly it can severely damage and/or kill the plant by applying too much pressure on the stem, causing a breakage or bleeding of the stem leaving the plant susceptible to infection and infestation. Because of this risk many grower choose not to use the high-stress training technique. The garden stem compression tool described herein can virtually eliminate the risk of breakage of bleeding to the plant stem.

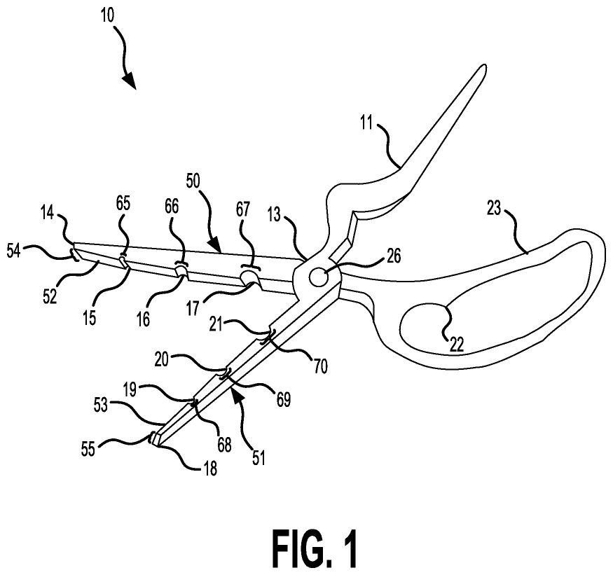

FIG. 1 illustrates a perspective view of a plant compression tool 10, according to some embodiments of the present invention. Plant compression tool 10 may include an upper shaft 50 and a lower shaft 51. Upper shaft 50 may be coupled to lower shaft 51 at a pivot point 26 such that upper shaft 50 is rotatable with respect to lower shaft 51 and/or lower shaft 51 is rotatable with respect to upper shaft 50. Plant compression tool 10 may include a fulcrum 13 surrounding pivot point 26. Fulcrum 13 may provide structure allowing upper shaft 50 and lower shaft 51 to rotate at pivot point 26. Upper shaft 50 may include an upper tip 14 at a distal end of upper shaft 50 and lower shaft 55 may include a lower tip 18 at a distal end of lower shaft 55.

In some embodiments, plant compression tool 10 may include an upper handle 11 and a lower handle 23 allowing a user to operate plant compression tool 10. For example, in some embodiments, bringing upper handle 11 and lower handle 23 toward each other may cause upper shaft 50 and lower shaft 51 to move toward each other and pulling upper handle 11 and lower handle 23 away from each other may cause upper shaft 50 and lower shaft 51 to move apart. In other embodiments, bringing upper handle 11 and lower handle 23 toward each other may cause upper shaft 50 and lower shaft 51 to move apart and pulling upper handle 11 and lower handle 23 away from each other may cause upper shaft 50 and lower shaft 51 to move toward each other. Upper handle 11 and lower handle 23 may have various ergonomic features for improving user comfort. For example, lower handle 23 may include a finger rest 22.

In the illustrated embodiment, upper handle 11 is integrated with lower shaft 51 and lower handle 23 is integrated with upper shaft 50. In various embodiments, upper handle 11 may be attached to or integrated with upper shaft 50, upper handle 11 may be attached to or integrated with lower shaft 51, lower handle 23 may be attached to or integrated with upper shaft 50, and/or lower handle 23 may be attached to or integrated with lower shaft 51. In some embodiments, upper handle 11 and lower handle 23 may be pivotably attached to each other via fulcrum 13. In some embodiments, upper shaft 50 and lower shaft 51 may be pivotably attached to each other via fulcrum 13. Other possibilities are contemplated.

Upper shaft 50 may include various notches disposed along an upper shaft edge 52 of upper shaft 50. Upper shaft edge 52 may be defined by an upper shaft edge width 54 which may correspond to (e.g., be equal to) to a width of upper shaft 50. In the illustrated embodiment, upper shaft 50 includes three notches disposed along upper shaft edge 52, including a first upper shaft notch 15 (defined by a first upper notch width 65), a second upper shaft notch 16 (defined by a second upper notch width 66), and a third upper shaft notch 17 (defined by a third upper notch width 67). The three notches can vary in size. In the illustrated embodiment, the second upper notch width 66 is greater than the first upper notch width 65, and the third upper notch width 67 is greater than the second upper notch width 66.

Each of notches 15, 16, 17 may have rounded shapes. For example, each of notches 15, 16, 17 may have semicircular shapes that form cylindrical cutouts from upper shaft 50. In embodiments in which notches 15, 16, 17 have semicircular shapes, widths 65, 66, 67 may correspond to diameters of the semicircular shapes. In some embodiments, the semicircular shapes may correspond to 50% of a circle. In other embodiments, the semicircular shapes may correspond to 40%, 30%, 20%, or 10% of a circle, or any values there between. In some embodiments, upper shaft edge width 54 may be greater than each of widths 65, 66, 67. In some embodiments, upper shaft edge width 54 may be equal to one of widths 65, 66, 67. In some embodiments, upper shaft edge width 54 may be less than each of widths 65, 66, 67.

Lower shaft 51 may include various notches disposed along an lower shaft edge 53 of lower shaft 51. Lower shaft edge 53 may be defined by an lower shaft edge width 55 which may correspond to (e.g., be equal to) to a width of lower shaft 51. In the illustrated embodiment, lower shaft 51 includes three notches disposed along lower shaft edge 53, including a first lower shaft notch 19 (defined by a first lower notch width 68), a second lower shaft notch 20 (defined by a second lower notch width 69), and a third lower shaft notch 21 (defined by a third lower notch width 70). The three notches can vary in size. In the illustrated embodiment, the second lower notch width 69 is greater than the first lower notch width 68, and the third lower notch width 70 is greater than the second lower notch width 69.

Each of notches 19, 20, 21 may have rounded shapes. For example, each of notches 19, 20, 21 may have semicircular shapes that form cylindrical cutouts from lower shaft 51. In embodiments in which notches 19, 20, 21 have semicircular shapes, widths 68, 69, 70 may correspond to diameters of the semicircular shapes. In some embodiments, the semicircular shapes may correspond to 50% of a circle. In other embodiments, the semicircular shapes may correspond to 40%, 30%, 20%, or 10% of a circle, or any values there between. In some embodiments, lower shaft edge width 55 may be greater than each of widths 68, 69, 70. In some embodiments, lower shaft edge width 55 may be equal to one of widths 68, 69, 70. In some embodiments, lower shaft edge width 55 may be less than each of widths 68, 69, 70.

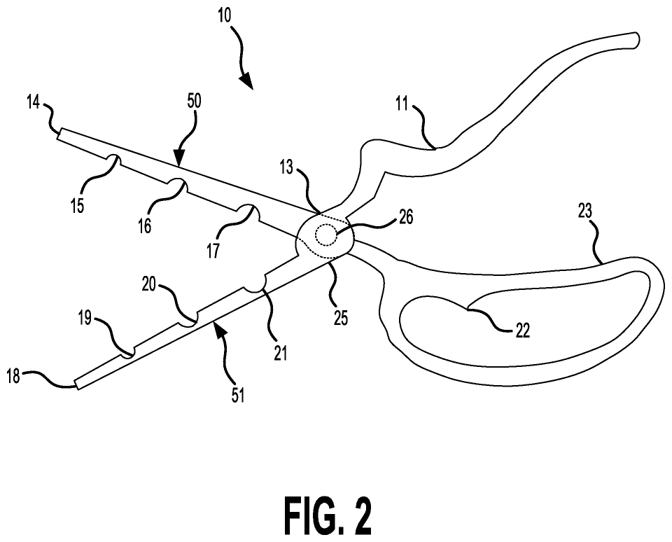

FIG. 2 illustrates a side view of plant compression tool 10, according to some embodiments of the present invention. The obscured portions of upper shaft 50 within fulcrum 13 are indicated by dashed lines.

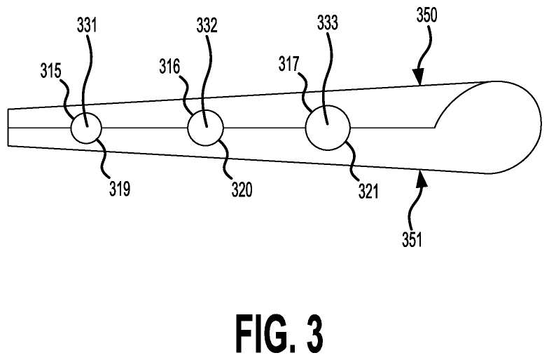

FIG. 3 illustrates a side view of an upper shaft 350 and a lower shaft 351 of the plant compression tool, according to some embodiments of the present invention. In the illustrated embodiment, the edge of upper shaft 350 is interfacing with the edge of lower shaft 351 such that a plurality of apertures 331, 332, 333 are formed. Specifically, a first upper notch 315 interfaces with a first lower notch 319 to form a first aperture 331, a second upper notch 316 interfaces with a second lower notch 320 to form a second aperture 332, and a third upper notch 317 interfaces with a third lower notch 321 to form a third aperture 333. The apertures 331, 332, 333 have circular shapes, causing a plant stem to be compressed evenly from all sides.

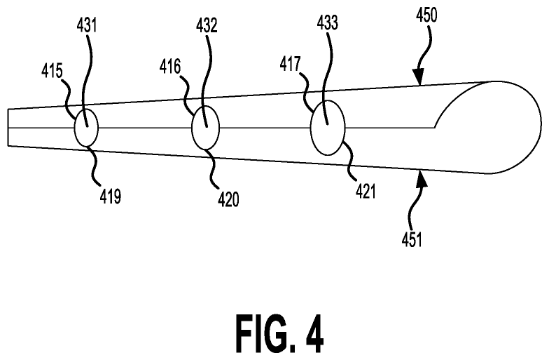

FIG. 4 illustrates a side view of an upper shaft 450 and a lower shaft 451 of the plant compression tool, according to some embodiments of the present invention. In the illustrated embodiment, the edge of upper shaft 450 is interfacing with the edge of lower shaft 451 such that a plurality of apertures 431, 432, 433 are formed. Specifically, a first upper notch 415 interfaces with a first lower notch 419 to form a first aperture 431, a second upper notch 416 interfaces with a second lower notch 420 to form a second aperture 432, and a third upper notch 417 interfaces with a third lower notch 421 to form a third aperture 433. The apertures 431, 432, 433 have elongated rounded shapes, which are elongated with respect to the radial direction of upper shaft 450 and lower shaft 451, causing a plant stem to be compressed more significantly in the longitudinal direction of upper shaft 450 and lower shaft 451.

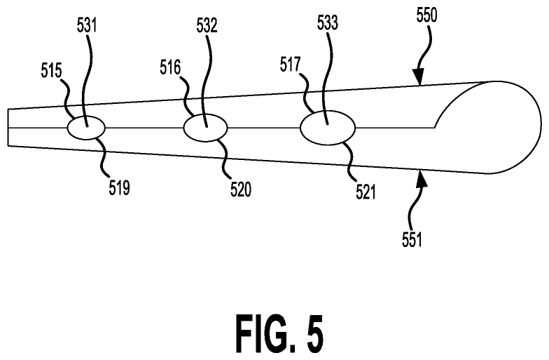

FIG. 5 illustrates a side view of an upper shaft 550 and a lower shaft 551 of the plant compression tool, according to some embodiments of the present invention. In the illustrated embodiment, the edge of upper shaft 550 is interfacing with the edge of lower shaft 551 such that a plurality of apertures 531, 532, 533 are formed. Specifically, a first upper notch 515 interfaces with a first lower notch 519 to form a first aperture 531, a second upper notch 516 interfaces with a second lower notch 520 to form a second aperture 532, and a third upper notch 517 interfaces with a third lower notch 521 to form a third aperture 533. The apertures 531, 532, 533 have elongated rounded shapes, which are elongated with respect to the longitudinal direction of upper shaft 550 and lower shaft 551, causing a plant stem to be compressed more significantly in the radial direction of upper shaft 550 and lower shaft 551.

In some embodiments, the plant compression tool may form both apertures consistent with FIG. 4 (i.e., elongated with respect to the radial direction) and apertures consistent with FIG. 5 (elongated with respect to the longitudinal direction). For example, a single plant compression tool may include notches 415, 416, 417, 419, 420, 421 so as to form apertures 431, 432, 433 as well as notches 515, 516, 517, 519, 520, 521 so as to form apertures 531, 532, 533. This can allow a user to compress a plant stem along multiple dimensions within a short time period of time using a single tool.

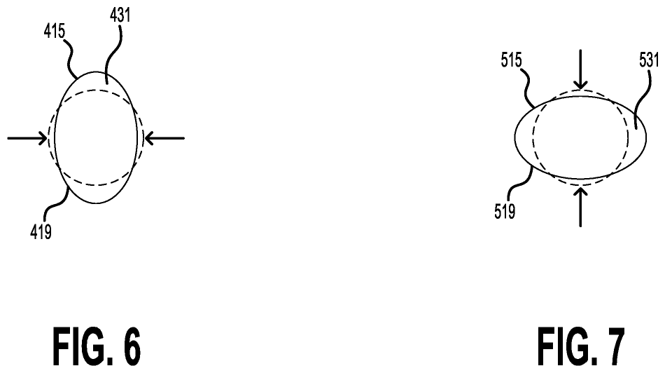

FIG. 6 illustrates a side view of an example of using the plant compression tool to compress a plant stem (indicated by the dashed lines) in the longitudinal direction. The example illustrated in FIG. 6 may correspond to the plant compression tool illustrated in FIG. 4.

FIG. 7 illustrates a side view of an example of using the plant compression tool to compress a plant stem (indicated by the dashed lines) in the radial direction. The example illustrated in FIG. 7 may correspond to the plant compression tool illustrated in FIG. 5.

### LIST OF TERMS:

10—Plant Compression Tool

11—Upper Handle

13—Fulcrum

14—Upper Tip

15, 315, 415, 515—First Upper Shaft Notch

16, 316, 416, 516—Second Upper Shaft Notch

17, 317, 417, 517—Third Upper Shaft Notch

18—Lower Tip

19, 319, 419, 519—First Lower Shaft Notch

20, 320, 420, 520—Second Lower Shaft Notch

21, 321, 421, 521—Third Lower Shaft Notch

22—Finger Rest

23—Lower Handle

24—Top Shaft

25—Bottom Shaft

26—Fulcrum Pivot Point

50, 350, 450, 550—Upper Shaft

51, 351, 451, 551—Lower Shaft

52—Upper Shaft Edge

53—Lower Shaft Edge

54—Upper Shaft Edge Width

55—Lower Shaft Edge Width

65—First Upper Notch Width

66—Second Upper Notch Width

67—Third Upper Notch Width

68—First Lower Notch Width

69—Second Lower Notch Width

70—Third Lower Notch Width

331, 431, 531—First Aperture

332, 432, 532—Second Aperture

333, 433, 533—Third Aperture

What is claimed is:

1. A handheld plant compression tool comprising:
an upper shaft having a plurality of upper shaft notches disposed along an edge of the upper shaft, the plurality of upper shaft notches varying in size and having rounded shapes;
a lower shaft having a plurality of lower shaft notches disposed along an edge of the lower shaft, the plurality of lower shaft notches varying in size and having rounded shapes; and
a handle attached to or integrated with one or both of the upper shaft and the lower shaft;
wherein the upper shaft and the lower shaft are coupled to each other at a pivot point such that, when the upper shaft or the lower shaft is rotated about the pivot point by moving the handle, the edge of the upper shaft interfaces with the edge of the lower shaft, and a plurality of apertures are formed by the plurality of upper shaft notches and the plurality of lower shaft notches.

2. The handheld plant compression tool of claim 1, wherein the plurality of upper shaft notches have semicircular shapes.

3. The handheld plant compression tool of claim 1, wherein the plurality of lower shaft notches have semicircular shapes.

4. The handheld plant compression tool of claim 1, wherein, when the edge of the upper shaft interfaces with the edge of the lower shaft, the plurality of apertures have circular shapes.

5. The handheld plant compression tool of claim 1, wherein, when the edge of the upper shaft interfaces with the edge of the lower shaft, the plurality of apertures have elongated rounded shapes.

6. The handheld plant compression tool of claim 5, wherein the plurality of apertures are elongated with respect to a longitudinal direction of the upper shaft and the lower shaft.

7. The handheld plant compression tool of claim 5, wherein the plurality of apertures are elongated with respect to a radial direction of the upper shaft and the lower shaft.

8. The handheld plant compression tool of claim 1, wherein the plurality of upper shaft notches include:
a first upper notch defined by a first upper notch height;
a second upper notch defined by a second upper notch height, wherein the second upper notch height is greater than the first upper notch height; and
a third upper notch defined by a third upper notch height, wherein the third upper notch height is greater than the second upper notch height.

9. The handheld plant compression tool of claim 8, wherein a width of the edge of the upper shaft is greater than each of the first upper notch height, the second upper notch height, and the third upper notch height.

10. The handheld plant compression tool of claim 1, wherein the plurality of lower shaft notches include:
a first lower notch defined by a first lower notch height;
a second lower notch defined by a second lower notch height, wherein the second lower notch height is greater than the first lower notch height; and
a third lower notch defined by a third lower notch height, wherein the third lower notch height is greater than the second lower notch height.

11. The handheld plant compression tool of claim 10, wherein a width of the edge of the lower shaft is greater than each of the first lower notch height, the second lower notch height, and the third lower notch height.

12. A hand tool comprising:
an upper shaft having a plurality of upper shaft notches disposed along an edge of the upper shaft, the plurality of upper shaft notches varying in size and having rounded shapes; and
a lower shaft having a plurality of lower shaft notches disposed along an edge of the lower shaft, the plurality of lower shaft notches varying in size and having rounded shapes;
wherein the upper shaft and the lower shaft are coupled to each other at a pivot point such that, when the upper shaft or the lower shaft is rotated about the pivot point, the edge of the upper shaft interfaces with the edge of the lower shaft, and a plurality of apertures are formed by the plurality of upper shaft notches and the plurality of lower shaft notches.

13. The hand tool of claim 12, wherein the plurality of upper shaft notches have semicircular shapes.

14. The hand tool of claim 12, wherein the plurality of lower shaft notches have semicircular shapes.

15. The hand tool of claim 12, wherein, when the edge of the upper shaft interfaces with the edge of the lower shaft, the plurality of apertures have circular shapes.

16. The hand tool of claim 12, wherein, when the edge of the upper shaft interfaces with the edge of the lower shaft, the plurality of apertures have elongated rounded shapes.

17. The hand tool of claim 16, wherein the plurality of apertures are elongated with respect to a longitudinal direction of the upper shaft and the lower shaft.

18. The hand tool of claim 16, wherein the plurality of apertures are elongated with respect to a radial direction of the upper shaft and the lower shaft.

19. The hand tool of claim 12, wherein the plurality of upper shaft notches include:
a first upper notch defined by a first upper notch height;
a second upper notch defined by a second upper notch height, wherein the second upper notch height is greater than the first upper notch height; and
a third upper notch defined by a third upper notch height, wherein the third upper notch height is greater than the second upper notch height.

20. The hand tool of claim 19, wherein a width of the edge of the upper shaft is greater than each of the first upper notch height, the second upper notch height, and the third upper notch height.
